(19) United States
(12) Patent Application Publication
(10) Pub. No.: US 2013/0059175 A1
(43) Pub. Date: Mar. 7, 2013

(54) BATTERY WITH DEGASSING SYSTEM AND METHOD FOR DISSIPATING EMERGING SUBSTANCES

(71) Applicants: Florian Engel, Munchen (DE); Ralf Angerbauer, Moglingen (DE); Holger Fink, Stuttgart (DE)

(72) Inventors: Florian Engel, Munchen (DE); Ralf Angerbauer, Moglingen (DE); Holger Fink, Stuttgart (DE)

(73) Assignee: ROBERT BOSCH GMBH, Stuttgart (DE)

(21) Appl. No.: 13/505,503

(22) PCT Filed: Sep. 21, 2010
(86) PCT No.: PCT/EP10/63853

§ 371 Date: Sep. 28, 2012

(30) Foreign Application Priority Data
Nov. 4, 2009 (DE) 10 2009 046 385.2

(51) Int. Cl. H01M 2/12

(52) U.S. Cl. 429/50; 429/82

(57) ABSTRACT

The invention relates to a battery with a degassing system and to a method for dissipating substances emerging from a battery, by which means the gases and electrolytes which result from chemical activity can be dissipated using simple means in this way, and battery cells are protected against damage. The invention provides that the battery with the degassing system comprises a base plate (22) and at least one cell module (12) which is arranged on the base plate (22) and has at least one battery cell (16), wherein the battery cell (16) has an upper face (34), which is provided with cell terminals (14), and a lower face (36), which is provided with at least one degassing opening (18), and the base plate (22) has at least one aperture to a catchment area at the location of the at least one degassing opening (18), wherein the lower face (36) is arranged opposite the upper face (34) and the lower face (36) is arranged below the upper face (34) in the direction of the force of gravity.

The invention relates to a battery having a degassing system and to a method for dissipating emerging substances from a battery, by which means the gases and electrolytes which are created by chemical activity can be dissipated in a manner using simple means, and cells of the battery are protected against damage.

### PRIOR ART

Battery cells, for example lithium-ion cells, require a degassing opening, since certain operating states can lead to an increased pressure in the cell. In order to prevent an explosion in the battery cell, the pressurized gases must be able to escape. However, the emergence of the gases can lead to damage to the battery pack, since the gases may contain electrolyte. These emerging substances can react together with water to form hydrofluoric acid. It is therefore necessary to deliberately dissipate gas emerging from the battery cell.

It is known for degassing openings to be arranged on the upper face of the cell modules, that is to say the face on which the poles are also positioned. Corresponding channels for gas dissipation therefore also run above the battery cells. In this case, the channels consist of flexible tubes which are connected to one another by means of plug connections.

For example, DE 600 03 843 T2 discloses a battery cover with a ventilation system, by means of which the gases created by the chemical activity are intended to be dissipated. For this purpose, the battery cover has an integrated gas collector, which is connected to a side channel with a depression in the cover side wall and opens in an intermediate chamber. A frit body is located in the depression and is arranged such that all gases are intended to flow through it and are intended to be passed to the open air via a degassing opening. A bottom of the intermediate chamber is in this case intended to be used as an electrolyte collector.

The arrangement of the degassing on the upper face of the individual battery cells means that complex line routing is necessary when there are a plurality of battery cells in one cell module. The lines consist of a large number of different components, which leads to increased material and assembly costs. Furthermore, the large number of joint points results in an increased risk of leaks, and therefore the danger of gas and electrolyte damaging battery cells.

Therefore, the invention is based on the object of providing a battery with an optimized degassing system, which avoids the problems mentioned above.

### DISCLOSURE OF THE INVENTION

This object is achieved by a battery having the features stated in claim 1, by a vehicle as claimed in claim 9, and by a method as claimed in claim 10.

The battery according to the invention comprises a degassing system, a base plate and at least one cell module, which is arranged on the base plate and has at least one battery cell, with the battery cell having an upper face, which is provided with cell terminals, and a lower face, which is provided with at least one degassing opening, and with the base plate having at least one aperture for a catchment area at the location of the at least one degassing opening, with the lower face being arranged opposite the upper face, and with the lower face being arranged under the upper face in the direction of the force of gravity.

This advantageously makes it possible to simplify the adaptation of the degassing channels. The electrical connections of the battery cells and the degassing channels need no longer be arranged in the same area. According to the invention, the degassing channels run under the cells or modules. The electrolyte therefore cannot contaminate any cells or other electrical contacts in the event of leaks in the channels. Since the degassing channels can be made simpler, the number of joints is reduced, and therefore the risk of leaks. The arrangement of the degassing openings according to the invention on the lower face makes use of the force of gravity to deliberately dissipate the emerging substances. The emerging substances are collected under the battery cells and the electrical components, and therefore also cannot cause any short circuits.

In one preferred refinement of the invention, the cell module is screwed to the base plate, and an O ring is arranged for sealing purposes between the at least one battery cell and the base plate. This advantageously makes it possible to achieve a cost-effective connection between the cell module and the base plate, and a cost-effective seal between the battery cell and the base plate. A shaped-out area for the O ring can easily be integrated in the contour of the base plate.

In a further preferred refinement of the invention, the at least one battery cell is a lithium-ion cell. Lithium-ion cells advantageously offer better performance than other cell types. They have a better weight-specific and mass-specific capacity, and a longer life.

In a further preferred refinement of the invention, the base plate has degassing channels. This advantageously makes it possible to save the number of different components, and therefore material and assembly costs. Furthermore, the reduction in the number of components reduces the probability of leaks occurring.

In a further preferred refinement of the invention, a collecting trough is integrated as a catchment area in the base plate. This advantageously makes it possible to minimize the length of the degassing channels, thus further reducing the number of components, and therefore saving weight and additional physical space.

In a further preferred refinement of the invention, at least one suitable means for cooling is integrated in the base plate. Therefore, the base plate advantageously has an additional function. There is no need for a separate unit with a cooling function.

In a further preferred refinement of the invention, the housing plate has at least one molding. This advantageously creates a connection option for dissipation of the emerging substances, that is to say the gases and electrolytes.

In a further preferred refinement of the invention, the molding comprises a non-return valve. This advantageously prevents emerging substances from flowing back to the battery cells.

The object is also achieved by a vehicle having the features mentioned in claim 9.

The vehicle according to the invention comprises a battery having a degassing system, a base plate and at least one cell module, which is arranged on the base plate and has at least one battery cell, with the battery cell having an upper face, which is provided with cell terminals, and a lower face, which is provided with at least one degassing opening, and with the base plate having at least one aperture for a catchment area at the location of the at least one degassing opening, with the lower face being arranged opposite the upper face, and with the lower face being arranged under the upper face in the direction of the force of gravity.

The reduced number of joints, and therefore the reduced risk of leaks, advantageously result in better operational reliability of the overall vehicle in which a battery according to the invention is installed.

Furthermore, the object is achieved by a method having the features mentioned in claim 10.

In the method according to the invention for dissipating emerging substances which emerge from battery cells at an increased pressure, the emerging substances are dissipated via at least one degassing opening on a lower face of the battery cell.

This advantageously makes it possible to simplify the adaptation of the degassing channels. The electrical connections of the battery cells and the degassing channels need no longer be arranged in the same area. According to the invention, the degassing channels run under the battery cells or modules. In the event of leaks in the channels, the electrolyte therefore cannot contaminate any cells or other electrical contacts. Since the degassing channels can be made simpler, the number of joints is reduced, and therefore the risk of leaks. The arrangement of the degassing openings according to the invention on the lower face makes use of the force of gravity in order to deliberately dissipate the emerging substances. The emerging substances are collected under the cells and the electrical components, and therefore also cannot cause any short circuits.

In one preferred refinement of the invention, the battery cell is mounted on a base plate, and the emerging substances are passed through channels in the base plate, or are captured in a collecting trough in the base plate. This advantageously minimizes the overall length of the degassing channels, thus further reducing the number of components and therefore saving weight and additional physical space.

In one preferred refinement of the invention, emerging substances from a plurality of battery cells are dissipated to a catchment area under the battery cells. This also advantageously reduces the number of components.

Further preferred refinements of the invention will become evident from the other features mentioned in the dependent claims.

The invention will be explained in the following text using exemplary embodiments and with reference to the associated drawings, in which:

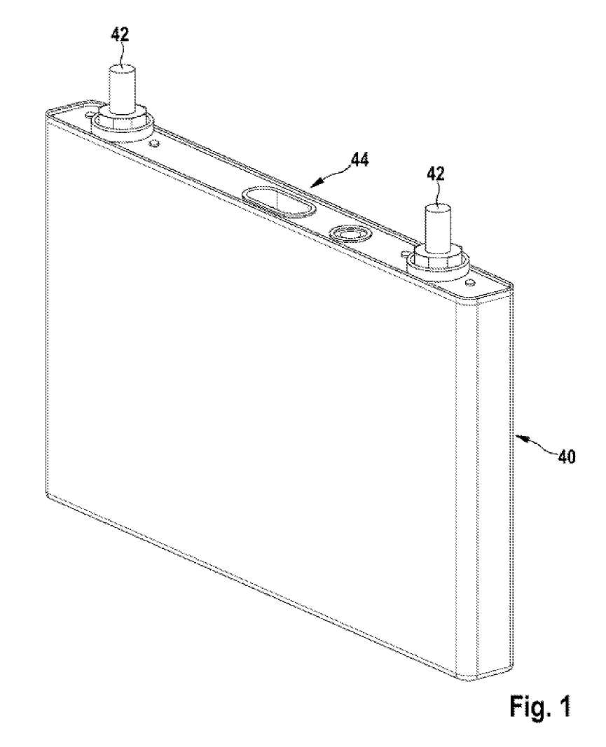

FIG. 1 shows a conventional battery cell, and

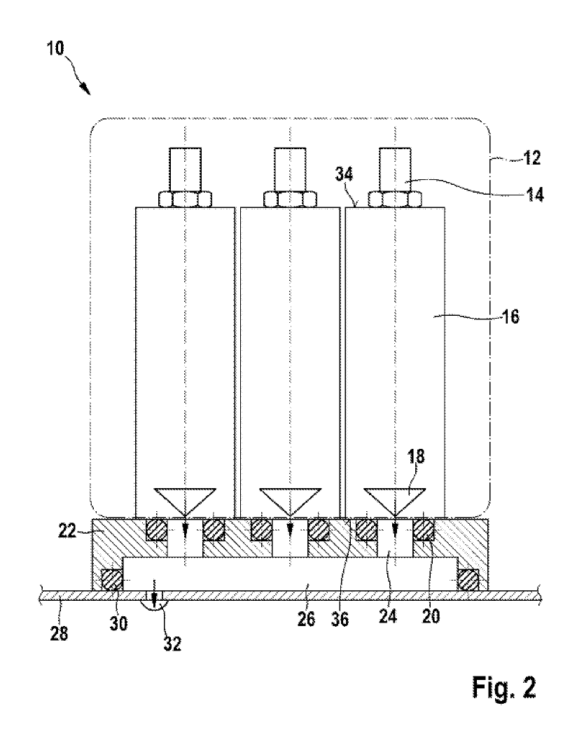

FIG. 2 shows a battery according to the invention with a degassing system.

FIG. 1 illustrates a conventional battery cell 40 according to the prior art. Both cell terminals 42 and a degassing opening 44 located at the top are located on the upper face thereof. If a battery consists of a plurality of these cells, a complicated line system is required in order to dissipate the gases and electrolytes which emerge from the degassing openings.

FIG. 2 illustrates a section through a battery 10 according to the invention with a degassing system. A base plate 22 is mounted on a housing plate 28. A housing plate seal 30 is arranged between the housing plate 28 and the base plate 22. A cell module 12 with three battery cells 16, in this case, is mounted on the base plate 22. On an upper face 34, each battery cell 16 has cell terminals 14. On a lower face 36, which is arranged opposite the upper face 34, each battery cell 16 is provided with a degassing opening 18 at the bottom. The degassing opening 18 of the battery cell 16 is in this case sealed directly to the base plate 22 via an O ring 20. Compression of this seal is in this case ensured by a screw connection of the entire cell module 12 to the base plate 22.

At the location where the battery cells 16 have degassing openings 18, the base plate 22 contains apertures 24, and in the illustrated embodiment these are produced by means of holes. Emerging electrolyte and emerging gas are deliberately dissipated through the apertures 24 to a catchment area. In the illustrated embodiment, the base plate 22 is provided with a collecting trough 26, which is used as a catchment area for the emerging substances from all three battery cells 16. According to the invention, it is likewise possible to arrange the catchment area outside the base plate 22. Furthermore, the base plate 22 may have degassing channels, by means of which the emerging substances are passed on. According to the invention, the catchment area can be designed such that it forms the lowest level of the battery or of a battery pack, that is to say all other components which can be damaged by the emerging substances are placed above it. Furthermore, the catchment area may be sealed with respect to the rest of a system, in which the battery according to the invention is used, in order to ensure that the emerging electrolyte cannot wet other components in the system, which could be damaged by this.

In the exemplary embodiment shown in FIG. 2, the housing plate 28 is provided with a molding 32 in the area of the collecting trough 26, in order to dissipate the emerging substances. By way of example, this may be a flange-connected non-return valve. The interface to the environment is represented in the degassing system.

In a further embodiment, according to the invention, it is also possible to integrate further functions in the base plate 22, in addition to those already mentioned. For example, the base plate 22 may comprise a cooling means, or may be part of a cooling system.

The battery 10 according to the invention may, for example, be used in a vehicle.

1. A battery having a degassing system comprising:
a base plate, and
at least one cell module, which is arranged on the base plate and has at least one battery cell, with the battery cell having an upper face, which includes cell terminals and a lower face, which defines at least one degassing opening, and with the base plate defining at least one aperture for a catchment area at the location of the at least one degassing opening, with the lower face being arranged opposite the upper face, and with the lower face being arranged under the upper face in the direction of the force of gravity.

2. The battery as claimed in claim 1, further comprising an O ring configured to provide a seal between the at least one battery cell and the base plate when the cell module is attached to the base plate.

3. The battery as claimed in claim 1, wherein the at least one battery cell is a lithium-ion cell.

4. The battery as claimed in claim 1, wherein the base plate defines degassing channels.

5. The battery as claimed in claim 1, wherein the catchment area includes a collecting trough that is integrated in the base plate.

6. The battery as claimed in claim 1, wherein the base plate is configured to cool the at least one cell module.

7. The battery as claimed in claim 1, further comprising a housing plate to which the base plate is mounted, the housing plate including at least one molding.

8. The battery as claimed in claim 7, wherein the molding includes a non-return valve.

9. A vehicle, comprising:
a battery having a degassing system which includes,
a base plate, and
at least one cell module, which is arranged on the base plate and has at least one battery cell, with the battery cell having an upper face, which includes cell terminals, and a lower face, which defines at least one degassing opening, and with the base plate defining at least one aperture for a catchment area at the location of the at least one degassing opening, with the lower face being arranged opposite the upper face, and with the lower face being arranged under the upper face in the direction of the force of gravity.

10. A method for dissipating emerging substances which emerge from battery cells at increased pressure comprising:
dissipating emerging substances via at least one degassing opening on a lower face of a battery cell of the battery cells.

11. The method as claimed in claim 10, further comprising:
passing the emerging substances through channels in a base plate to which the battery cell is mounted.

12. The method as claimed in claim 10, wherein emerging substances from a plurality of battery cells are dissipated to a catchment area under the battery cells.

13. The method as claimed in claim 10, further comprising:
capturing the emerging substances in a collecting trough in a base plate to which the battery cell is mounted.
